(19) United States
(12) Patent Application Publication
(10) Pub. No.: US 2009/0164810 A1
(43) Pub. Date: Jun. 25, 2009

(54) METHODS, APPARATUSES, AND COMPUTER PROGRAM PRODUCTS FOR MANAGING POWER USAGE IN MOBILE DEVICES

(75) Inventors: Jaakko Henrikki Kyro, Helsinki (FI); Perttu Mikael Makkonen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/962,462

(22) Filed: Dec. 21, 2007

(51) Int. Cl. G06F 21/00; G06F 9/46; G06F 1/26

(52) U.S. Cl. 713/310; 718/102; 726/21; 713/300

(57) ABSTRACT

An apparatus for managing power usage in mobile devices may include a processor. The processor may be configured to determine whether authorization to use a power source exists and to execute one or more functionalities using power provided by the power source if authorization exists. Corresponding methods and computer program products are also provided.

### TECHNOLOGICAL FIELD

Embodiments of the present invention relate generally to mobile communication technology and, more particularly, relate to methods, apparatuses, and computer program products for managing power usage in mobile devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

This explosive growth of mobile communications networks has followed the evolution of mobile devices, such as cellular phones, personal digital assistants (PDAs), and other portable electronic devices from luxury items to ubiquitous devices integrated into the everyday lives of individuals from all walks of life. The widespread adoption of mobile devices and expanding capabilities of the wireless networks over which they communicate has allowed for a tremendous expansion in the functionalities which mobile devices are capable of executing. In addition to providing for phone service, many mobile devices now execute functionalities such as navigation services through the use of GPS, camera and video capturing capabilities, digital music and video playback, and web browsing.

While this expansion in functionality of mobile devices has been revolutionary, it does have a drawback in that each added functionality requires additional power to execute and in some cases, the power consumption of some functionalities, such as a camera with a flash or GPS receiver may be quite substantial. This increased power consumption may present a problem to users of mobile devices by rapidly draining mobile device batteries as power storage capacity of batteries has remained essentially constant in comparison to the exponential growth in the capabilities of mobile devices. Draining of mobile device batteries may be particularly troublesome for device users in situations where the user is traveling or otherwise is not in close proximity to an alternative power source to charge or otherwise power the mobile device battery. These additional functionalities may drain battery power to the point where a mobile device is not even capable of executing a simple phone call. In some instances, functionalities may draw so much power that even when a mobile device is connected to an alternative power source, the alternative power source cannot provide enough power to both power one or more functionalities of the device and to charge the mobile device battery. Thus, as a result, utilization of these additional power-consuming functionalities may leave a user with a powerful mobile device, but no power to operate any functionalities of the device.

In some instances in which multiple functionalities with high power requirements are executing concurrently, an amount of current may be drawn from the battery that is sufficient to cause voltage to decrease. In extreme cases, current consumption may cause voltage to drop below a cut-off value, which may effectively turn the device off. Further problems may be generated from drawing a large amount of current in that the more current that is drawn from a battery, the more heat is generated. In extreme cases, this generated heat may damage electronic components of the device or may cause discomfort to a device user.

Furthermore, power consumption by mobile devices may impact the environment. Energy required to charge mobile device batteries may result in pollution, such as from being produced by fossil fuels, as well as depletion of non-renewable energy resources. Furthermore, disposal of spent mobile device batteries, which may contain toxic compounds may also result in problematic environmental impact.

Accordingly, it would be advantageous to provide methods, apparatuses, and computer program products that provide for reduced or otherwise managed power consumption within mobile devices and as such prolong mobile device battery life.

### BRIEF SUMMARY

A method, apparatus, and computer program product are therefore provided to improve the experience of mobile device users. In particular, a method, apparatus, and computer program product are provided to intelligently manage power usage in mobile devices. Accordingly, users of mobile devices may experience greater battery life in their mobile devices.

In one exemplary embodiment, a method is provided which may comprise determining whether authorization to use a power source exists and executing one or more functionalities using power provided by the power source if authorization exists. The method may further comprise determining whether authorization to use a power source exists by requesting authorization to use the power source from a power management entity or by executing a coordination function. The method may additionally comprise sending, in conjunction with a request for authorization, an indication of a maximum duration for which the power source will be used.

In another exemplary embodiment, a computer program product is provided, which includes at least one computer-readable storage medium having computer-readable program code portions stored therein. The computer-readable program code portions include first and second executable portions. The first executable portion is for determining whether authorization to use a power source exists. The second executable portion is for executing one or more functionalities using power provided by the power source.

In another exemplary embodiment, an apparatus is provided which includes a processor. The processor may be configured to determine whether authorization to use a power source exists and to execute one or more functionalities using power provided by the power source.

In another exemplary embodiment, a method is provided which may comprise determining whether a battery associated with a device is charged to at least a first predefined level, determining whether any scheduled functionalities are presently due to be executed by the device, and executing one or more scheduled functionalities presently due to be executed until the battery is no longer charged to at least a second predefined level.

In another exemplary embodiment, a computer program product is provided, which includes at least one computer-readable storage medium having computer-readable program code portions stored therein. The computer-readable program code portions include first, second, and third executable portions. The first executable portion is for determining whether a battery associated with a device is charged to at least a first predefined level. The second executable portion is for determining whether any scheduled functionalities are presently due to be executed by the device. The third executable portion is for executing one or more scheduled functionalities presently due to be executed until the battery is no longer charged to at least a second predefined level.

Embodiments of the invention may therefore provide a method, apparatus, and computer program product managing power usage in mobile devices. As such, mobile device users may benefit from greater battery life of batteries associated with their mobile devices.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a flowchart illustrating a method for managing power usage in mobile devices in accordance with one embodiment of the present invention; and

FIG. 3 is a flowchart illustrating another method for managing power usage in mobile devices in accordance with one embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

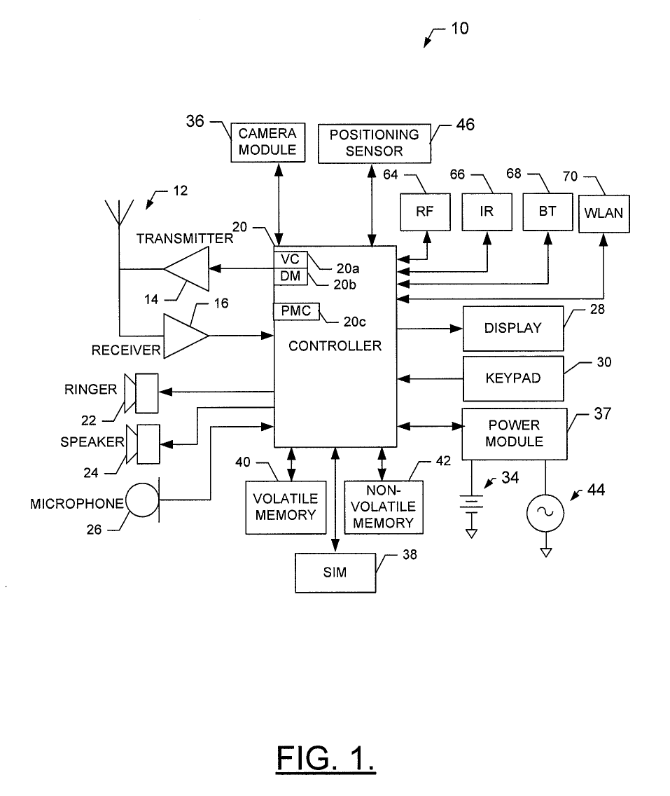

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ embodiments of the present invention.

As shown, the mobile terminal 10 may include an antenna 12 in communication with a transmitter 14, and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be configured to operate in accordance with 3G wireless communication protocols such as UMTS network employing WCDMA radio access technology. Some NAMPS, as well as TACS, mobile terminals may also benefit from the teaching of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50. The controller 20 may additionally comprise a power management controller (PMC) 20C, described more fully below, which may manage and monitor power use in the mobile terminal 10 and selectively enable and disable functionalities of the mobile terminal according to power states or other predefined criteria within the device.

The mobile terminal 10 may also comprise a user interface including a conventional earphone or speaker 24, a ringer 22, a microphone 26, a display 28, a user input interface, and/or the like, which may be coupled to the controller 20. The mobile terminal may comprise a battery 34 for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

In an exemplary embodiment, mobile terminal 10 may further comprise a power module 37, in communication with the PMC 20c of controller 20. As used herein, the term “exemplary” merely refers to an example and should not be construed to refer to a “preferred” embodiment. The power module 37 may be any means, hardware or software, for delivering power to mobile terminal 10. In some embodiments, power module 37 may be a software implementation controlled by a processor, such as, for example, controller 20 of mobile terminal 10. As such, the power module 37 may include all hardware, and software necessary for delivering power to mobile terminal 10. Alternatively, in some embodiments, power module 37 may include only the hardware needed to provide for the use of supplemental power source 44 by mobile terminal 10. Supplemental power source 44 may be an adapter permitting the connection of mobile terminal 10 to an alternative power source, such as an AC power source or a vehicle battery. The alternative power source may be used to power mobile terminal 10 as well as to charge the battery 34. In an exemplary embodiment, power module 37 may further monitor the power level remaining in the battery 34 and communicate the status of the battery life of battery 34 to the PMC 20c. An indication of the battery life status may further be displayed to a user of the mobile terminal via display 28.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal 10 may further include a WLAN transceiver 70 capable of transmitting and/or receiving data from electronic devices according various wireless networking techniques, including Wireless Fidelity (Wi-Fi), WLAN techniques such as IEEE 802.11 techniques, and/or the like.

In an exemplary embodiment, the mobile terminal 10 may include a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. In addition, the digital camera of the camera module 36 may be capable of capturing a video clip. As such, the camera module 36 may include all hardware, such as a lens or other optical component(s), and software necessary for creating a digital image file from a captured image as well as a digital video file from a captured video clip. Alternatively, the camera module 36 may include only the hardware needed to view an image, while a memory device of the mobile terminal 10 stores instructions for execution by the controller 20 in the form of software necessary to create a digital image file from a captured image. As yet another alternative, an object or objects within a field of view of the camera module 36 may be displayed on the display 28 of the mobile terminal 10 to illustrate a view of an image currently displayed which could be captured if desired by the user. As such, as referred to hereinafter, an image could be either a captured image or an image comprising the object or objects currently displayed by the mobile terminal 10, but not necessarily captured in an image file. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

The mobile terminal 10 may include a positioning sensor 46. The positioning sensor 46 may include, for example, a global positioning system (GPS) sensor, an assisted global positioning system (Assisted-GPS) sensor, etc. In one embodiment, however, the positioning sensor includes a pedometer or inertial sensor. Further, the positioning sensor may determine the location of the mobile terminal based upon signal triangulation or other mechanisms. The positioning sensor may be configured to determine a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, the memory of the mobile terminal may store instructions for determining cell id information. In this regard, the memory may store an application program for execution by the controller 20, which determines an identity of the current cell, i.e., cell id identity or cell id information, with which the mobile terminal is in communication. In conjunction with the positioning sensor, the cell id information may be used to more accurately determine a location of the mobile terminal. In an exemplary embodiment, the positioning sensor 46 may comprise an accelerometer and/or pedometer, which may be used in obtaining a position fix for the mobile terminal 10 or to determine a state of motion of the mobile terminal 10. In embodiments where the positioning sensor comprises a GPS sensor or the like, a state of motion of the mobile terminal 10 may also be determined. In this regard, the positioning sensor may be configured to determine whether the mobile terminal 10 is in motion based upon whether the location of the mobile terminal 10 is changing over an interval 10. In exemplary embodiments, the positioning sensor may be configured to determine a degree or severity of this state of motion based upon, for example, the distance traveled by the mobile terminal 10 over a time interval.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

In an exemplary embodiment, the PMC 20c may be configured to manage access to one or more power sources by power-demanding functionalities of a mobile terminal 10. As used herein, the term “functionalities” is to be construed as encompassing hardware modules, such as, for example, the camera module 36 and positioning sensor 46 as well as software applications and other software routines which may be executed by or otherwise controlled by the controller 20, such as audio or video player applications, web browsers, and e-mail programs. As such, the PMC 20c may be configured to manage access to one or more power sources of a mobile terminal 10 by using a mutual exclusion mechanism so that only one power-consuming functionality at a time may have access to power provided by a power source of the mobile terminal 10. As such, the power consuming functionalities of the system may be synchronized and the power consumption of the system as a whole may be maintained within operational limits. This intelligent synchronization of power-consuming functionalities may allow for more power-consuming functionalities in a mobile terminal 10 than are currently possible. In some embodiments, a mobile terminal 10 may have multiple associated power sources, such as two or more batteries 34. In such embodiments, the PMC 20c may be configured to manage access to each of the associated power sources independently and thus each power source may provide power to one functionality at a time.

In one approach to synchronizing power load, herein referred to as the “centralized approach,” the PMC 20c may be configured as a management (or coordinator) entity that manages all of the power-consuming functionalities prior to any functionality performing an energy-intensive operation. As such, the PMC 20c may be configured to receive requests for authorization to use a power source from one or more functionalities of a mobile terminal 10 and to determine whether such authorization should be granted.

In one embodiment of the centralized approach, the PMC 20c may be configured to grant authorization to requesting functionalities on a simple first-come-first-served basis. As such, if, for instance the camera module 36 requests access to the battery 34 prior to the positioning sensor 46 then the PMC 20c may grant authorization to the camera module 36 first and then the positioning sensor 46 may wait until the camera module 36 is through using the power source. In other embodiments, the PMC 20c may be configured to grant authorization to requesting functionalities according to a priority scheme. In such embodiments, a priority listing may be stored in memory, such as non-volatile memory 42 and in instances where multiple functionalities request access to the battery 34 simultaneously or in very close proximity to each other, the PMC 20c may be configured to grant authorization to the requesting functionality with the highest predefined functionality first. In some embodiments in which the PMC 20c is configured to grant authorization according to a priority scheme, the PMC 20c may be configured to interrupt a functionality with a low priority that is currently using a power source in response to a request from a functionality with a higher priority and to then grant authorization to use the power source to the requesting functionality with the higher priority.

In some embodiments using the centralized approach, the PMC 20c may be configured to prevent deadlocks in which one functionality monopolizes a power source at the expense of other functionalities by enforcing time limits on how long a functionality may use a power source. As such, there may be a predefined upper time limit on the length of consecutive time that a functionality may have access to power provided by a power source and once a functionality reaches that time limit, the PMC 20c may be configured to send an indication to the functionality to relinquish the power source so that authorization may be granted to a requesting functionality waiting for access to the power source. In other embodiments, the PMC 20c may be configured to receive an indication of an upper duration for requested power access from a requesting functionality and to enforce the indicated upper duration by sending an indication to relinquish the power source to any functionality that uses the power source for the full duration that it initially indicated upon request. Alternatively, individual functionalities may be configured to relinquish the power source after the expiration of their time window without the PMC 20c sending an indication to do so. In such embodiments in which a functionality requests authorization to use a power source for a duration of time, the PMC 20c may be further configured to authorize requests in an order other than first-come-first served based upon an algorithm or other criteria to optimize power management wherein requests are authorized in an order based upon the duration of time for which a functionality requests to use the power source.

In another exemplary embodiment, the PMC 20c may be configured to manage access to one or more power sources based upon an approach referred to herein as the “distributed approach.” In the distributed approach, the PMC 20c may be configured to grant access to a functionality that has determined that it has authorization to use a power source. As such, in the distributed approach, it is the functionalities themselves which determine whether they have authorization to use a power source and then once a functionality has determined that it has authorization, it may request access to the power source from the PMC 20c. The functionalities may be configured to determine amongst themselves which has authorization to use a power source based upon a coordination function that may ensure no collisions will occur, i.e. only one functionality at a time is allowed to perform power-intensive operations. Optimally in such an approach, the functionalities may be able to communicate with each other and may use any of a number of well known medium access protocols to avoid collision, such as, for example token-based access mechanisms, commonly used in networking of computing devices, wherein an access “token” is circulated among the functionalities and access is only possible when a functionality is holding the “token.” In some embodiments using the distributed approach, the functionalities may be able to measure the overall power consumption or may otherwise receive an indication of a measure of the overall power consumption, such as from the PMC 20c or from the power module 37 and as such may use the measure as a criterion for determining access to a power source.

In an exemplary embodiment, the PMC 20c may be configured to control the execution of scheduled functionalities in certain situations, such as when a mobile terminal 10 has entered a power-savings mode (sometimes referred to as “sleep mode,” “standby mode,” or “night mode”) or may otherwise be connected to a supplemental power source 44 for purposes of charging the battery 34. Mobile terminals 10 not using embodiments of the present invention, which are in a power-savings mode may not execute certain functionalities, even if they are functionalities which are scheduled to occur periodically, such as fetching e-mail, until a user of the mobile terminal 10 reactivates the mobile terminal 10 from the power-saving mode. While, the disabling of scheduled functionalities may serve to conserve power, such as when remaining power in battery 34 is low, standard power-savings modes may not take into account changed battery conditions, such as when battery 34 is charged by supplemental power source 44. Accordingly, in an exemplary embodiment, the PMC 20c may be configured to take into account changed battery status when the mobile terminal 10 is in a power savings mode and to control the execution of scheduled functionalities accordingly.

In such an exemplary embodiment, the PMC 20c may be in communication with the power module 37 or may otherwise determine or receive an indication of a current power level remaining in a battery 34. As such, the PMC 20c may be configured to determine whether the battery 34 is charged to at least a predefined level, such as during or following charging by a supplemental power source 44, to execute a scheduled functionality. As used herein, “predefined level” may be fully charged or may be some point less than fully charged, such as a predefined percentage of fully charged. If the PMC 20c determines that the battery 34 is charged to a predefined level, then the PMC 20c may be further configured to determine whether any functionalities are either currently scheduled to be executed or were previously scheduled to be executed but were cancelled or otherwise delayed due to the mobile terminal 10 being in power savings mode. If the PMC 20c determines that scheduled functionalities are scheduled to be currently performed or were scheduled to previously be confirmed and were cancelled or otherwise delayed, the PMC 20c may select one or more functionalities and may then have the one or more functionalities executed, such as by the controller 20. Following execution of the one or more scheduled functionalities, the PMC 20c may be configured to again determine whether the battery 34 is charged to a predefined level. On the second and all subsequent such determinations, the predefined level may be the same predefined level as previously or may be some a lower threshold level. In this regard, multiple scheduled functionalities which may drain the battery 34 more rapidly than it is being recharged by the supplemental power source 44 may be executed consecutively without having a “ping-pong” effect wherein functionality execution is shut on and off due to the charge level of battery 34 fluctuating across a single predefined threshold level. If the battery is not charged to the predefined level, the PMC 20c may be configured to wait until the battery 34 is again sufficiently charged. If, however, the battery 34 remains charged to a predefined level, the PMC 20c may be configured to determine whether there are any further scheduled functionalities due to be performed and if so may perform them. The PMC 20c may be configured to repeat this process until all scheduled functionalities have been performed (It will be appreciated that scheduled functionalities have a “timeout” period, such as every 15 minutes, between scheduled executions and as such the process may begin anew once a scheduled functionality is again due to be executed) or until the mobile terminal 10 exits the power savings mode.

Embodiments of the invention in which the PMC 20c is configured to manage the execution of scheduled functionalities are not limited by the order in which the scheduled functionalities are performed. However, in an exemplary embodiment the PMC 20c may be configured to first execute any functionalities that are scheduled to currently be executed. The PMC 20c may then execute any functionalities that were scheduled to previously be executed but were cancelled or otherwise delayed by the power savings mode. The reason behind such logic would be that scheduled functionalities are often performed periodically after the expiration of a “timeout” period and as such following a time delay the timeout period may expire again. Thus, it may not only be redundant to execute the same functionality twice in a period shorter than the timeout period, but may also waste power resources as well. As such, any functionalities that were previously cancelled or delayed in which the timeout period has expired again may be cancelled and any functionalities for which the timeout period is about to expire again may be delayed until they are next due to be executed.

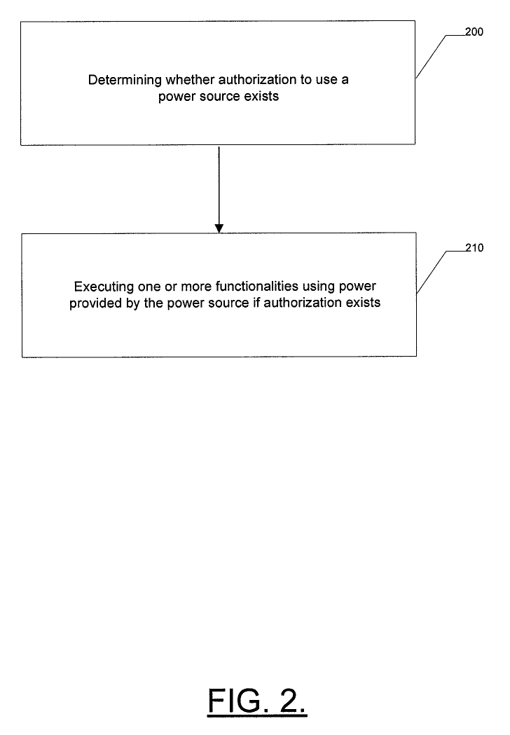

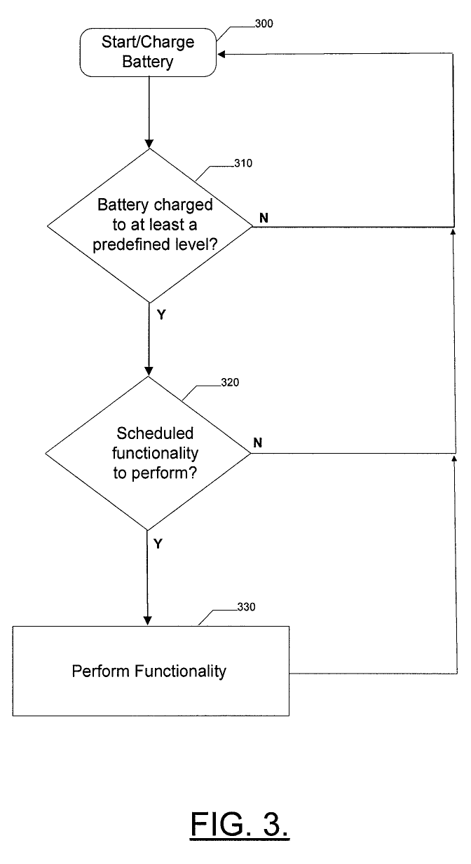

FIGS. 2 and 3 are flowcharts of methods and computer program products according to exemplary embodiments of the invention. It will be understood that each block or step of the flowcharts, and combinations of blocks in the flowcharts may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a processor of a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one embodiment of a method for managing power usage in a mobile device as depicted in FIG. 2 may include determining whether authorization to use a power source exists, at operation 200. As discussed above, the determination step may be performed by a functionality by polling the PMC 20c or may be performed by a functionality executing a coordination function. Next, at operation 210, a hardware or software implemented functionality may execute one or more functionalities using power provided by the power source if authorization exists.

Referring now to FIG. 3, a flowchart according to an exemplary method for managing power usage in a mobile device based upon the state of a battery is illustrated. Initially at operation 300, the battery may be charged. Next, at operation 310, the PMC 20c, power module 37, or some combination thereof may determine whether the battery 34 is charged to at least a predefined level. If the battery is not charged to at least a predefined level, then the method may return to operation 300 wherein the battery 34 may be further recharged, such as by the supplemental power source 44. If on the other hand at operation 300, the PMC 20c determines that the battery is charged to at least a predefined level, then the PMC 20c may determine at operation 320 whether there is a scheduled functionality to perform. If there is not a scheduled functionality to perform, then the method may return to operation 300 wherein the PMC 20c may wait for both the battery to be fully charged and for there to be a scheduled functionality to perform. If, however, at operation 320 the PMC 20c determines that there is a scheduled functionality to perform then the PMC 20c may authorize the functionality to be performed at operation 330. After performing the functionality, the method may return to operation 300 to ensure the battery remains charged to at least a predefined level prior to executing any further scheduled functionalities.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, embodiments of the invention provide several advantages for mobile device users who may use their mobile devices for a variety of tasks important to their everyday lives. These tasks, or functionalities, which a mobile device is capable of executing may consume a significant amount of power in situations wherein there is a limited level of power in a battery of the device or where it is otherwise desirable to conserve power. Embodiments of the invention provide several ways in which power consumption in mobile devices may be intelligently managed so as to extend battery life and minimize the occurrence of problems associated with unchecked power consumption in mobile devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
determining whether authorization to use a power source exists; and
executing one or more functionalities using power provided by the power source if authorization exists.

2. The method of claim 1, wherein determining whether authorization to use a power source exists comprises requesting authorization to use the power source from a power management entity.

3. The method of claim 2, wherein executing one or more functionalities using power provided by the power source comprises executing one or more functionalities using power provided by the power source until receiving an indication to relinquish the power source.

4. The method of claim 2, further comprising:
Sending, in conjunction with a request for authorization, an indication of a maximum duration for which the power source will be used; and
wherein executing one or more functionalities using power provided by the power source comprises executing one or more functionalities using power provided by the power source for no longer than either until the indicated maximum duration has passed or until receiving an indication to relinquish the power source.

5. The method of claim 1, wherein determining whether authorization to use a power source exists comprises executing a coordination function.

6. A computer program product comprising at least one computer-readable storage medium having computer-readable program code portions stored therein, the computer-readable program code portions comprising:
a first executable portion for determining whether authorization to use a power source exists; and
a second executable portion for executing one or more functionalities using power provided by the power source if authorization exists.

7. The computer program product of claim 6, wherein the first executable portion includes instructions for determining whether authorization to use a power source exists by requesting authorization to use the power source from a power management entity.

8. The computer program product of claim 7, wherein the second executable portion includes instructions for executing one or more functionalities using power provided by the power source until receiving an indication to relinquish the power source.

9. The computer program product of claim 7, further comprising:
a third executable portion for sending, in conjunction with a request for authorization, an indication of a maximum duration for which the power source will be used; and
wherein the second executable portion includes instructions for executing one or more functionalities using power provided by the power source for no longer than either until the indicated maximum duration has passed or until receiving an indication to relinquish the power source.

10. The computer program product of claim 6, wherein the first executable portion includes instructions for determining whether authorization to use a power source exists by executing a coordination function.

11. An apparatus comprising a processing element configured to:
determine whether authorization to use a power source exists; and
execute one or more functionalities using power provided by the power source if authorization exists.

12. The apparatus of claim 11, wherein the processing element is further configured to determine whether authorization to use a power source exists by requesting authorization to use the power source from a power management entity.

13. The apparatus of claim 12, wherein the processing element is further configured to execute one or more functionalities using power provided by the power source until receiving an indication to relinquish the power source.

14. The apparatus of claim 12, wherein the processing element is further configured to:
send an indication, in conjunction with a request for authorization, of a maximum duration for which the power source will be used; and
to execute one or more functionalities using power provided by the power source for no longer than either until the indicated maximum duration has passed or until receiving an indication to relinquish the power source

15. The apparatus of claim 11, wherein the processing element is further configured to determine whether authorization to use a power source exists by executing a coordination function.

16. A method comprising:
determining whether a battery associated with a device is charged to at least a first predefined level;
determining whether any scheduled functionalities are presently due to be executed by the device; and
executing one or more scheduled functionalities presently due to be executed until the battery is no longer charged to at least a second predefined level.

17. The method of claim 16, wherein determining whether any scheduled functionalities are presently due to be executed by the device comprises one or more of determining whether any functionalities are currently scheduled to be executed and determining whether any functionalities were previously scheduled to be executed but have not yet been executed because the device was in a power saving mode.

18. The method of claim 16, wherein executing one or more scheduled functionalities presently due to be executed until the battery is no longer charged to at least a second predefined level comprises first executing any functionalities currently scheduled to be executed followed by executing any functionalities that were previously scheduled to be executed but have not yet been executed because the device was in a power saving mode.

19. The method of claim 16, wherein the second predefined level is less than or equal to the first predefined level.

20. A computer program product comprising at least one computer-readable storage medium having computer-readable program code portions stored therein, the computer-readable program code portions comprising:
a first executable portion for determining whether a battery associated with a device is charged to at least a first predefined level;
a second executable portion for determining whether any scheduled functionalities are presently due to be executed by the device; and
a third executable portion for executing one or more scheduled functionalities presently due to be executed until the battery is no longer charged to at least a second predefined level.

21. The computer program product of claim 20, wherein the second executable portion includes instructions for determining whether any scheduled functionalities are presently due to be executed by the device by one or more of determining whether any functionalities are currently scheduled to be executed and determining whether any functionalities were previously scheduled to be executed but have not yet been executed because the device was in a power saving mode.

22. The computer program product of claim 20, wherein the third executable portion includes instructions for executing one or more scheduled functionalities presently due to be executed until the battery is no longer charged to at least a second predefined level by first executing any functionalities currently scheduled to be executed followed by executing any functionalities that were previously scheduled to be executed but have not yet been executed because the device was in a power saving mode.

23. The computer program product of claim 20, wherein the second predefined level is less than or equal to the first predefined level.
